(19) United States
(12) Patent Application Publication
(10) Pub. No.: US 2011/0069339 A1
(43) Pub. Date: Mar. 24, 2011

(54) NETWORK PRINTING COMMUNICATION METHOD AND APPARATUS

(75) Inventors: Hung Huang, Irvine, CA (US); Loren Wood, Lakewood, CA (US)

(73) Assignee: CANON KABUSHIKI KAISHA, Tokyo (JP)

(21) Appl. No.: 12/563,611

(22) Filed: Sep. 21, 2009

(51) Int. Cl. G06F 3/12

(52) U.S. Cl. 358/1.15

(57) ABSTRACT

A method and apparatus that provides means for printer communication. The method and apparatus includes receiving, based on a user logging onto a client device and submitting a print job from the client device, a first print job owner information and logged-on user information, wherein, the first print job owner information and the logged-on user information are associated with each other based on the print job, storing the associated first print job owner information and logged-on user information, receiving a request including a second print job owner information based on the print job, determining whether the second print job owner information is identical to the first print job owner information, determining, when the second print job owner information and the first print job owner information are identical, whether the user is currently logged on to the client device based on the logged-on user information associated with the first print job owner, and displaying information to the user or prompting the user to input information.

### BACKGROUND OF THE INVENTION

1. Field of the Invention

The present invention relates to a network printing communication method and apparatus, more specifically, a method and apparatus for print communication using an asynchronous user interface.

2. Description of the Related Art

An asynchronous User Interface (AsyncUI) mechanism, such as that provided in Microsoft® Windows Vista™, enables a printer driver to provide asynchronous event notification messages to a client computer independently of the spooler. The AsyncUI provides a set of interfaces that allows applications or printer driver components to register to receive notifications of print events.

Conventionally, a component called AsyncNotify runs in the spooler process and maintains a cross-session channel that connects the spooler process to a user's session. When the printer driver needs to notify the application of an event or, request input from the end-user, it can send a notification using the AsyncUI mechanism. Upon receiving this notification, the AsyncNotify component sends notifications over the channel to all registered applications and components in the user's session that are listening to that channel. User interface notifications sent through AsyncUI can be unidirectional or bidirectional. A unidirectional notification is one that presents information to the user but does not require a user response. A bidirectional notification does require a response from the user.

To handle this problem, companies such as Microsoft™ have introduced asynchronous user interfaces into their operating systems. These interfaces allow printer drivers on remote servers to send message boxes to a user's session at a client device over the network. Messages can include notifications and custom message boxes prompting users for information needed at the remote server. Although this provides a solution for communication, problems with this approach arise when the remote server requires input from the client device user for printing.

In these situations, client users may connect to the remote printer through the remote server under different credentials than those used for their current session at the client device. This causes messages sent from the printer driver to the client device to be lost because the print driver sends messages based on the credential used by the client user to connect to the remote printer. Since this credential is different from the credential for the user session on the client device, the messages never reach the users at the client devices. The non-delivery of messages halts printing because the server cannot send requests for necessary user information. This results in stoppage of the print queue sequence and printing at the remote printer all together.

### SUMMARY OF THE INVENTION

To solve the aforementioned problems, an embodiment of the present invention is directed to a method and apparatus to allow printer communication between a client device and another network-connected device using an asynchronous user interface.

According to an aspect of the present invention, there is provided a method for printer communication, the method comprising, receiving, based on a user logging onto a client device and submitting a print job from the client device, a first print job owner information and logged-on user information, wherein, the first print job owner information and the logged-on user information are associated with each other based on the print job, storing the associated first print job owner information and logged-on user information, receiving a request including a second print job owner information based on the print job, determining whether the second print job owner information is identical to the first print job owner information, determining, when the second print job owner information and the first print job owner information are identical, whether the user is currently logged on to the client device based on the logged-on user information associated with the first print job owner, and displaying information to the user or prompting the user to input information.

Further features of the present invention will become apparent from the following description of exemplary embodiments (with reference to the attached drawings).

### BRIEF DESCRIPTION OF THE DRAWINGS

FIG. 1 is a block diagram illustrating a print communication system using an asynchronous user interface system to display a message to a user according to an exemplary embodiment of the present invention.

FIG. 2 is a block diagram of a client device configured to print and display a message to the user according to the exemplary embodiment of the present invention.

FIG. 3 is a block diagram of a server device configured to print upon client user input according to the exemplary embodiment of the present invention.

FIG. 4 is a flow diagram illustrating a user at a client device printing a document and displaying a message to the user according to the exemplary embodiment of the present invention.

### DESCRIPTION OF THE EMBODIMENTS

Exemplary embodiments of the present invention provide for printing communication over a network using an asynchronous user interface. Pursuant to these exemplary embodiments, a user at a network connected client device can print a document and view notifications sent from a printer driver.

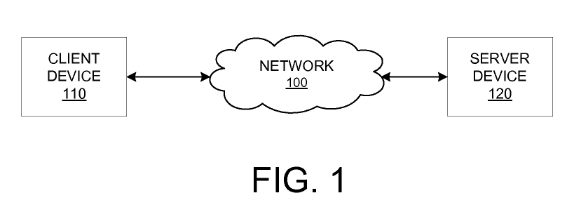

FIG. 1 is a block diagram illustrating a print communication system using an asynchronous user interface system to display a message to a user according to an exemplary embodiment of the present invention. In the present embodiment, a user at a client device 110 sends a print job to be remotely printed over a network 100. The print job is rendered at a server device 120 that requires information to be displayed to and inputted by a user at the client device 110 before printing can begin. The system according to the present embodiment includes a client device 110, a network 100, and a server device 120.

The network 100 can be any network allowing transport of data between devices communicatively coupled to the network 100. In general, data can take the form of, but is not limited to, documents, digital photos, and digital media files. The network 100 can be private or public, wired or wireless, in whole or in part.

The client device 110 can be, but is not limited to, a personal computer, a digital lifestyle device, television, or digital reading/display device that is communicatively coupled to the network 100. In general, a user establishes a user session on the client device 110 to print a document at a remote printer over the network 100. The user does so by logging on to the client device 110 using credentials and employing a print application that sends print data to the server device 120 over the network 100.

The server device 120 can be any computer system or equivalent that provides services to other computing systems over a network. Generally, the server device 120 stores the rasterizer of a print driver for rendering print jobs sent from the client device 110 over the network 100. Additionally, the server device 120 has an asynchronous user interface mechanism that allows a print driver to send notification messages to and receive notification messages from a client device 110 communicatively coupled to the network 100, independent of a spooler. In the present embodiment, before printing is started, the server device 120 checks connection status of the client device 110 to confirm the connection and requests information from the client device 110 upon confirmation.

While the present invention describes a single server and a single client communicatively connected to the network 100, a plurality of clients and a plurality of servers can be communicatively coupled to the network 100.

In the exemplary embodiment, the system is shown with a separate client device 110 and server device 120 to show instances where a print job sent from the client device 110 is rendered on a detached server device 120.

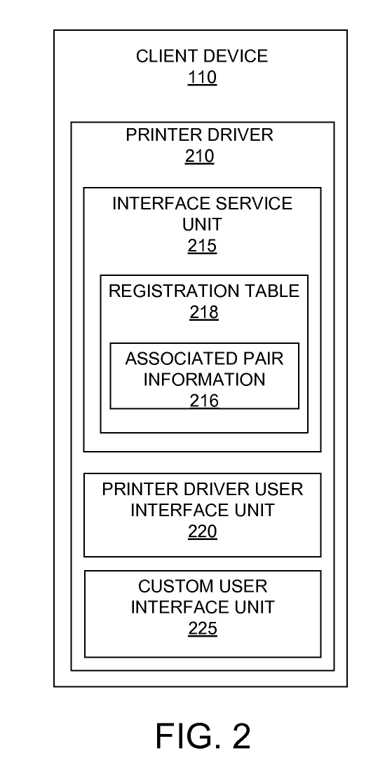

FIG. 2 is a block diagram of a client device configured to print and display a message to the user according to the exemplary embodiment of the present invention. The client device 110 includes, but is not limited to, a printer driver 210.

Generally, the printer driver 210 allows applications to convert print data for printing to a specific printer. In general, the printer driver 210 includes an interface service unit 215, a printer driver user interface unit 220, and a custom user interface unit 225.

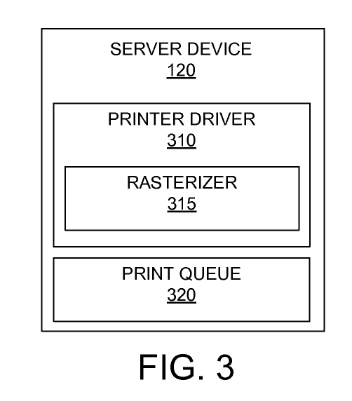

The interface service unit 215 manages and stores information and includes a registration table 218. In the present embodiment, the associated pair information 216 is registered and stored in the registration table 218. The registration table 218 is accessible for verifying and retrieving the stored associated pair information 216. Additionally, the interface service unit 215 invokes the custom user interface unit 225 when requested by the rasterizer 315 of the server device 120 described below in FIG. 3. Moreover, the interface service unit 215 determines whether specific information is stored in the registration table 218.

The registration table 218 stores associated pair information 216 including information related to each other. In general, associated pair information 216 is information associated in some manner by set criteria. Because of the association, knowing one part of the information allows the retrieval and knowledge of the counterpart information. In this embodiment, the associated pair information 216 is job owner information of a print job and logged-on user information from the client device 110 where the print job originated. The job owner information is based on the account used to connect to the server device 120. Logged-on user information is based on the logged-on user that submitted a print job at the client device 110. Moreover, the logged-on user is the current user logged on to the client device 110 and the user who should receive any user interface notifications from the custom user interface unit 225.

The printer driver user interface unit 220 is usually present in a standard printer driver and is responsible for obtaining the associated pair information 216 of a print job including job owner information and logged-on user information from the print job. Additionally, the printer driver user interface unit 220 registers the associated pair information 216 with the interface service unit 215 for storing in the registration table 218.

The custom user interface unit 225 displays a user interface to the user of the client device 110. In general, the user interface displays a message prompting the user at the client device 110 to input information needed from the user and returns the information to the interface service unit 215.

FIG. 3 is a block diagram of a server device configured to print upon client user input according to the exemplary embodiment of the present invention. The server device 120 includes, but is not limited to, a printer driver 310 and a print queue 320.

The printer driver 310 converts print data and commands from an application to correctly control and print to a specific printer. Generally, the printer driver 310 is included in the operating system of a computing device and includes a rasterizer 315.

The rasterizer 315 is responsible for rasterizing received print jobs. In addition, the rasterizer 315 obtains job owner information and the name of the client device 110 that created a print job from the received print job data stored in the print queue 320 described below. This is done by querying the print queue 320 on the server device 120. In the present embodiment, calls include, but are not limited to, GetJob and the appropriate structure such as JOB_INFO_{—}1 and JOB_INFO_{—}2 all of which are well known and thus a detailed description thereof is omitted herein. With this information, the rasterizer 315 is able to send a request, using the obtained job owner information, to the custom user interface unit 225 at the client device 110 that created the print job using the obtained client device name.

The print queue 320 has the ability to send, receive, and store print data. Generally, the print queue 320 manages print jobs sent by client devices 110 over the network 100 for printing. Moreover, the print queue 320 is responsible for receiving print job data, including job owner information and the name of the client device 110 that created the print job, from the client device 110 when a user initiates document printing to a network-connected printer managed by the server device 120.

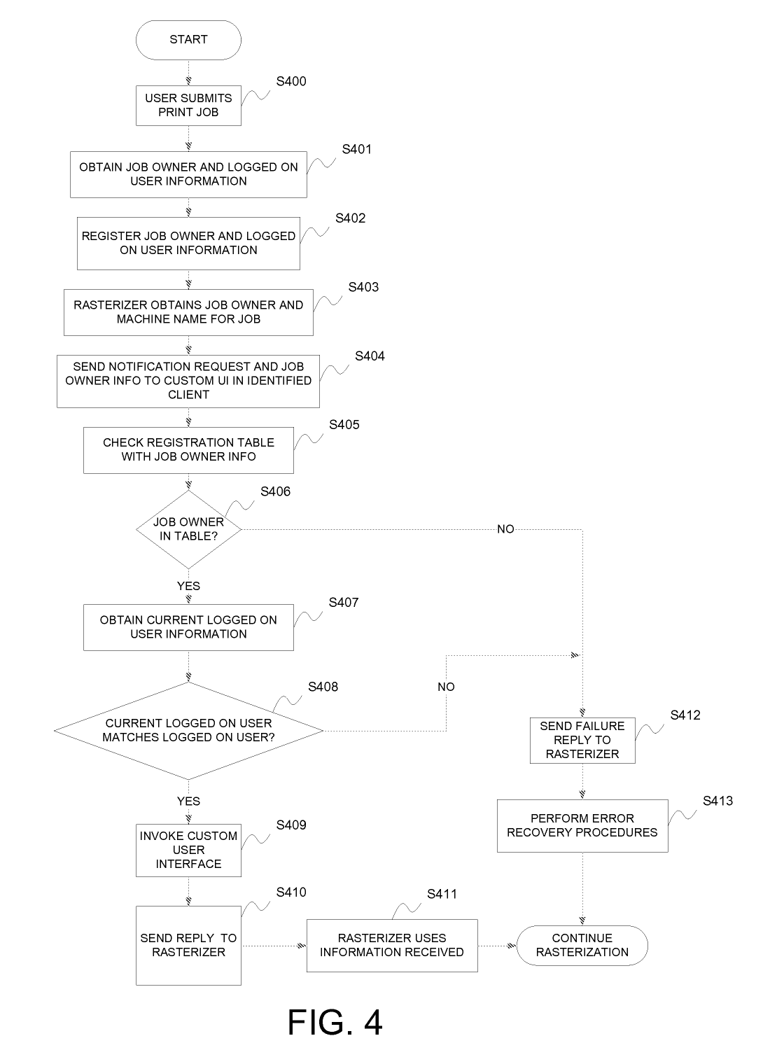

FIG. 4 is a flow diagram illustrating printing a document from a client device and displaying of a message at the client device according to the exemplary embodiment of the present invention. The process begins with a user at the client device 110 submitting a print job from an application (step S400).

In step S401, the printer driver user interface unit 220 obtains job owner information and logged-on user information based on the submitted print job. Then, the printer driver user interface unit 220 sends the obtained job owner information and the logged-on user information to the interface service unit 215 where the information is registered in the registration table 218 and stored as a pair associated with each other (step S402).

Next, in step S403, the rasterizer 315 obtains job owner information of the print job and the name of the client device 110 that created the print job from the print job data stored in the print queue 320. As described above, the rasterizer 315 sends a request that calls the appropriate function and structure to obtain this information from the print data stored in the print queue 320 of the server device 120.

In step S404, the rasterizer 315 sends a notification request over the network 100 to the interface service unit 215 of the appropriate client device 110 based on the client device 110 name obtained from the print queue 320 that created the print job. Generally, the notification request requires the user of the client device 110 that sent the print job, to input data to continue printing. Additionally, the rasterizer 315 sends job owner information to the interface service unit 215.

In step S405, the interface service unit 215 compares the received job owner information with the stored associated pair information 216 in the registration table 218. Next, in step S406, the interface service unit 215 determines whether the job owner information is stored in the registration table 218. Upon determining that the job information is stored in the registration table 218 (Yes in step S406), logged-on user information associated as the counter-part of the received job owner information is obtained from the registration table 218 (step S407).

Then in step S408, the interface service unit 215 determines whether the logged-on user information obtained from the registration table 218 matches the logged-on information of the current user at the client device 110. If the logged-on user information obtained from the interface service unit 215 matches the logged-on information of the current user at the client device 110 (YES in Step S408), the custom user interface unit 225 of the client device 110 is invoked (Step S409) by the interface service unit 215. Upon invoking the custom user interface unit 225, a notification is displayed to the user at the client device 110 requesting input of information or notifying the user of an event. For example, the user of client device 110 is prompted for information regarding the sent print job. After receiving either inputted information from the user and/or confirmation of the receipt of a notification, a reply is sent from the custom user interface unit 225 to the interface service unit 215.

In step S410, the interface service unit 215 sends the information received from the reply from the custom user interface unit 225, to the rasterizer 315 of the server device 120 over the network 100 (step S410). When the rasterizer 315 receives the information, the rasterizer 315 processes the information and uses it (step S411) to continue rasterization of the print job.

Referring back to step S406, if the job information is not stored in the registration table 218 (NO in step S406), processing proceeds to step S412 and a failure reply notification is sent to the rasterizer 315 from the custom user interface unit 225 over the network 100. The rasterizer 315 then performs error recovery procedures (step S413) based on the type of error to allow continuation of rasterization and printing of the print job.

Referring back to step S408, if the logged-on information obtained from the interface service unit 215 does not match the logged-on information of the current user at the client device 110 (NO in Step S408), the interface service unit 215 sends a failure reply notification to the rasterizer 315 over the network 110 (step S412). As described above, the rasterizer 315 then performs error recovery based on the type of error (step S413) to allow continuation of rasterization and prevent stalling of future print jobs for lack of user input.

The above-described exemplary embodiments may be achieved by an apparatus executing computer-executable process step. In such a case, the computer-executable process steps and any associated data may be supplied to the apparatus using a computer-readable storage medium including, but not limited to, an optical disc, a flash memory, a floppy disc, or an external computer-readable storage medium via a network or direct connection.

In this way, the computer-readable storage medium storing the computer-executable process can achieve the function(s) of the above-described exemplary embodiments. Thus, the present invention can be achieved by causing a computer (central processing unit (CPU) or micro-processing unit (MPU)) of a system or apparatus to read and execute the computer-executable process steps stored on the computer-readable storage medium.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures and functions.

What is claimed is:

1. A method for printer communication, the method comprising:
receiving, based on a user logging onto a client device and submitting a print job from the client device, a first print job owner information and logged-on user information,
wherein, the first print job owner information and the logged-on user information are associated with each other based on the print job;
storing the associated first print job owner information and logged-on user information;
receiving a request including a second print job owner information based on the print job;
determining whether the second print job owner information is identical to the first print job owner information;
determining, when the second print job owner information and the first print job owner information are identical, whether the user is currently logged on to the client device based on the logged-on user information associated with the first print job owner; and
displaying information to the user or prompting the user to input information.

2. The method of claim 1, wherein the associated first print job owner information and the logged-on user information are stored in a table.

3. The method of claim 1, wherein receipt of the request including the second print job owner information based on the print job is via an asynchronous notification mechanism.

4. The method of claim 1, wherein the information displayed to the user or prompting the user to input information is via a user interface notification.

5. The method of claim 1, wherein the user is prompted to input information to print the print job.

6. An apparatus for printer communication, the apparatus comprising:
a rasterizer configured to receive, based on submitting a print job at the client device, a first print job owner information and logged-on user information,
wherein, the first print job owner information and the logged-on user information are associated with each other based on the print job;
an interface service unit configured to receive a request including a second print job owner information based on the print job;
a storing unit configured to store the associated first print job owner information and logged-on user information,
wherein the interface service unit, upon receipt of the user interface request, determines whether the second print job owner information is identical to the first print job owner information, and
wherein the interface service unit determines, when the second print job owner information and the first print job owner information are identical, whether the user is currently logged onto the client device based on the logged-on user information associated with the first print job owner information; and
a custom user interface unit configured to display information to the user or prompt the user to input information.

7. The apparatus of claim 6, wherein the storing unit stores the associated first print job owner information and logged-on user information in a table.

8. The apparatus of claim 6, wherein the interface service unit receives the request including the second print job owner information based on the print job via an asynchronous notification mechanism.

9. The apparatus of claim 6, wherein the custom user interface unit displays information to the user or the user is prompted to input information, via a user interface notification.

10. The apparatus of claim 6, wherein the custom user interface unit prompts the user to input information to print the print job.

11. A computer-readable storage medium storing a computer-executable process, the computer-executable process causing a computer to perform a method for printer communication, the method comprising:
receiving, based on a user logging onto a client device and submitting a print job from the client device, a first print job owner information and logged-on user information,
wherein, the first print job owner information and the logged-on user information are associated with each other based on the print job;
storing the associated first print job owner information and logged-on user information;
receiving a request including a second print job owner information based on the print job;
determining whether the second print job owner information is identical to the first print job owner information;
determining, when the second print job owner information and the first print job owner information are identical, whether the user is currently logged on to the client device based on the logged-on user information associated with the first print job owner; and
displaying information to the user or prompting the user to input information.
